(19) United States
(12) Patent Application Publication
(10) Pub. No.: US 2026/0061720 A1
(43) Pub. Date: Mar. 5, 2026

(54) METHOD OF MANUFACTURING A PADDED MAILER

(71) Applicant: Premier Packaging, LLC, Louisville, KY (US)

(72) Inventors: Michael Shawn Edwards, Calhoun, GA (US); Timothy Kauffmann, Louisville, KY (US); David Phillips, Louisville, KY (US); Kurt George Melia, Buckner, KY (US)

(21) Appl. No.: 18/824,452

(22) Filed: Sep. 4, 2024

(51) Int. Cl. B31B 70/64; B31B 70/16; B31B 70/26; B31B 70/88; B31B 160/10; B31B 170/20

(52) U.S. Cl. CPC B31B 70/649; B31B 70/262; B31B 70/88; B31B 70/16; B31B 2160/10; B31B 2170/20

(57) ABSTRACT

A method of producing a mailer is described. The method includes: placing a first paper on a first unwind cradle, where the first paper includes a first side coated with a heat sealable coating and an uncoated second side; placing a second paper on a second unwind cradle, where the second paper includes a first side coated with the heat sealable coating and an uncoated second side; mating the first paper and the second paper using a heated band roller running in a machine direction, forming a mated paper; folding the mated paper, forming a folded mated paper; and heat sealing, without use of adhesive, the folded mated paper to create a width of the mailer.

### BACKGROUND OF THE INVENTION

There exist several mailers and methods of manufacturing said mailers for enclosing and shipping documents and packages. Many of these mailers are not recyclable and may ultimately end up in a landfill. Furthermore, many of these mailers are manufactured utilizing various adhesives to seal the layers of paper forming the mailer together. The use of such adhesives is not only expensive, but also requires equipment (e.g., sprayers, rollers, valves, etc.) that may be expensive to operate and maintain. Additionally, these adhesives may also require fine control of environmental humidity and/or temperature to prevent changes in viscosity of the adhesive and/or clogging of delicate machine components.

Furthermore, while there are mailers with adhesive seals on three sides of the mailer, these designs are typically slow to produce. Often, only a single mailer may be produced at a time. Additionally, these designs of mailers may not be curbside recyclable.

There exists a need in the art for a mailer that is curbside recyclable, or otherwise easily recycled by a consumer, and manufactured without the use of adhesives for sealing the layers of paper that form the mailer. Accordingly, an objective of the implementations described herein is to provide a consistent manufacturing method for a mailer, which in some instances may include an embossed or raised mirror pattern for additional padding, where the mailer is formed without the use of adhesives.

### SUMMARY OF THE INVENTION

The present application discloses one or more of the features recited in the appended claims and/or the following features which alone or in any combination, may comprise patentable subject matter.

The object of the embodiments described herein is to provide a method of producing a mailer. In a first aspect, the method includes: placing a first paper on a first unwind cradle, where the first paper includes a first side coated with a heat sealable coating and a second side; placing a second paper on a second unwind cradle, wherein the second paper includes a first side coated with the heat sealable coating and a second side; mating the first paper and the second paper using a heated band roller running in a machine direction to form a mated paper; folding, via a guided folder, the mated paper to form a folded mated paper; and heat sealing, without use of adhesive, the folded mated paper to create a width of the mailer.

In some implementations, the heat sealable coating is a low-density polyethylene. In some implementations, the first paper is a 40-pound kraft paper, a 50-pound kraft paper, or a 60-pound kraft paper.

In some implementations, the method additionally includes cutting the folded mated paper to a desired width.

In some implementations, the heated band roller is a first heated band roller and there is a second heated band roller, and there is a gap between the first and second heated band rollers.

In another aspect a method of producing a padded mailer includes: placing a first paper on a first unwind cradle, where the first paper includes a first side with a heat sealable coating and a second side; feeding the first paper through an embosser to create a raised mirror pattern to form an embossed paper; placing a second paper on a second unwind cradle, wherein the second paper includes a first side with a heat sealable coating and a second side; mating the embossed paper with a heated band roller running in a machine direction to form a mated paper; folding, via a guided folder, the mated paper to form a folded mated paper; and heat sealing, without use of adhesive, the folded mated paper to create a width of the padded mailer.

In some implementations, the heat sealable coating is a low-density polyethylene. In some implementations, the first paper is a 40-pound paper, a 50-pound paper, or a 60-pound paper.

In some implementations, mating the embossed paper with the second paper further includes leaving a lip section on the second paper. In some implementations, the method additional includes applying a closure adhesive to the lip section of the mailer.

In some implementations, the method of producing a padded mailer of claim 6 further includes cutting the folded mated paper to a desired width. In some implementations, feeding the first paper through an embosser to create a raised mirror pattern further includes applying heat. In some such implementations, the application of heat is through a radiant heater. In some implementations, the embosser includes a convex roller and a concave roller.

The method of producing a padded mailer of claim 6, wherein the heated band roller is a first heated band roller and there is a second heated band roller, wherein there is a gap between the first heated band roller and the second heated band roller.

In yet another aspect, a method of producing a padded mailer includes: placing a first paper on a first unwind cradle, wherein the first paper includes a first side with a heat sealable coating and a second side; feeding the first paper through an embosser while applying heat to create a raised mirror pattern to form an embossed paper; placing a second paper on a second unwind cradle, where the second paper includes a first side with a heat sealable coating and a second side; mating the embossed paper with a heated band roller running in the machine direction to form a mated paper; where the mating step additionally includes leaving a lip section on the second paper; folding, via a guided folder, the mated paper to form a folded mated paper; applying a closure adhesive to the lip section; and heat sealing, without use of adhesive, the folded mated paper to create a width of the padded mailer.

In some implementations, the heated band roller is a first heated band roller and there is a second heated band roller, where there is a gap between the first and second heated band rollers.

### BRIEF DESCRIPTION OF THE DRAWINGS

In order that the embodiments may be better understood, embodiments of a method of manufacturing a mailer will now be described by way of examples. These embodiments are not to limit the scope of the claims as other embodiments of a method of manufacturing a mailer will become apparent to one having ordinary skill in the art upon reading the instant description. Non-limiting examples of the present embodiments are shown in figures wherein:

FIG. 1 illustrates an exemplary mailer consistent with some embodiments described herein.

FIG. 2 is an exemplary schematic diagram of a portion of a machine system intended to emboss paper consistent with some embodiments described herein.

FIG. 3 is a schematic diagram of an exemplary top view of the portion of the machine system of FIG. 2 consistent with some embodiments described herein.

FIG. 4 is an exemplary schematic diagram of a portion of a machine system intended to heat seal papers together consistent with some embodiments described herein.

FIG. 5 is a schematic diagram of an exemplary top view of the portion of the machine system of FIG. 4 consistent with some embodiments described herein.

FIGS. 6A-C are schematic diagrams of the folding of a mailer consistent with some embodiments described herein. FIG. 6A illustrate a first stage of the folding; FIG. 6B illustrates a second stage of the folding; FIG. 6C illustrates a third stage of the folding.

FIG. 7 is a schematic diagram of a portion of a machine system with a continuous length of a folded paper consistent with some embodiments described herein.

FIG. 8 is a schematic diagram of a top view of the portion of the machine system of FIG. 7 consistent with some embodiments described herein.

FIG. 9 is a schematic diagram of a top view of the portion of the machine system intended to apply a closure adhesive for use by a consumer to a lip section of the mailer.

FIG. 10 is a schematic diagram of a top view of the portion of the machine system intended to cross-cut the mated and folded paper into individual mailers.

FIG. 11 is a flowchart illustrating an exemplary method of manufacturing a mailer consistent with some embodiments described herein.

### DETAILED DESCRIPTION OF THE INVENTION

It is to be understood that the method of manufacturing a padded mailer is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

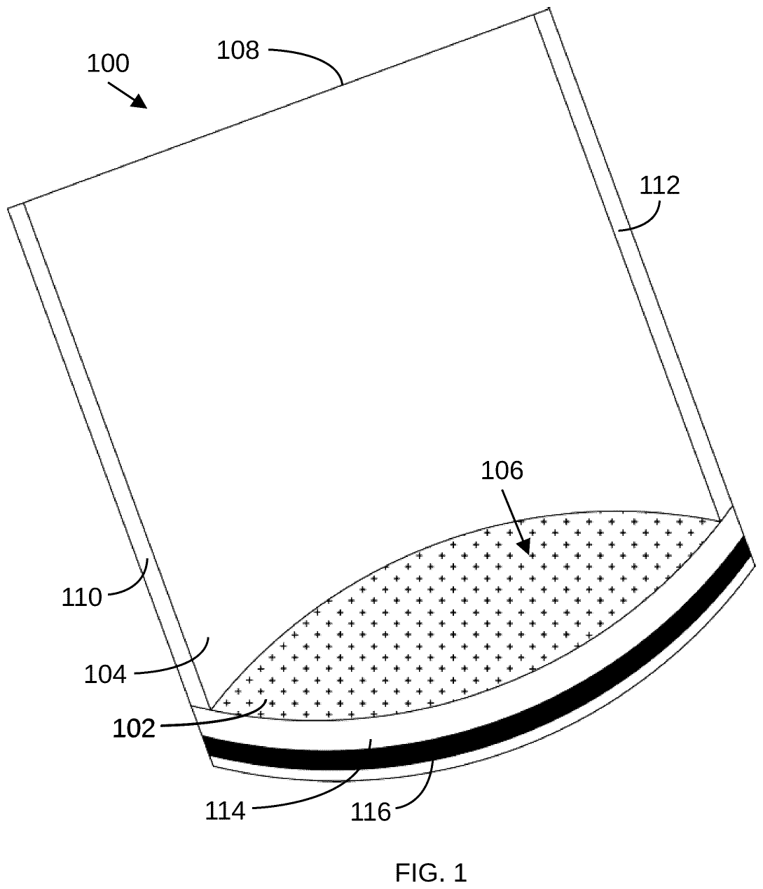

FIG. 1 illustrates an exemplary mailer 100 consistent with some embodiments discussed herein. The mailer 100 is formed of two layers of paper—a first paper 102 and a second paper 104. Each of the first paper 102 and the second paper 104 may be a kraft paper of varying weight. Each of the first paper 102 and the second paper 104 includes a heat sealable coating, such as a polyolefin coating or a polyethylene coating (e.g., a low-density polyethene coating), on one side of the kraft paper that forms the first paper 102 and the second paper 104. In some embodiments, such as illustrated in FIG. 1, the first paper 102 may be embossed or have a raised mirror pattern 106. Where present, this embossing or raised mirror pattern 106 may be about 1 mm to about 2 mm in height. This embossing or raised mirror pattern may also be in any suitable form (e.g., in some embodiments the embossing may be a rounded design, a semi-circular design, or the like). As illustrated in the embodiment of FIG. 1, the embossing or raised mirror pattern 106 faces in both directions (e.g., toward the exterior and the interior of the mailer), for example to provide padding or cushioning to the contents of the mailer 100. However, in other implementations, it may be possible for the embossing or the raised mirror pattern to be in only one direction/plane, in such instances, the embossing could face toward the interior or exterior of the mailer. Such an embodiment using an embossing, or a raised mirror pattern, may be referred to as a “padded mailer”.

As will be described in detail herein, the first paper 102 and the second paper 104 are mated and folded using a heat-sealing process to form the mailer 100. This mating and folding results in a width edge 108, a first heat sealed edge 110, and a second heat-sealed edge 112 to form the mailer 100. The mailer further includes a lip section 114, where a closure adhesive 116 (e.g., double-sided tape) may be applied for use by a consumer or end user to seal the mailer 100 once the desired contents are placed inside of the mailer. In some embodiments, the mailer 100 may contain less than about 15% plastic or “non-recoverable” material, which may make the mailer 100 more suitable for recycling.

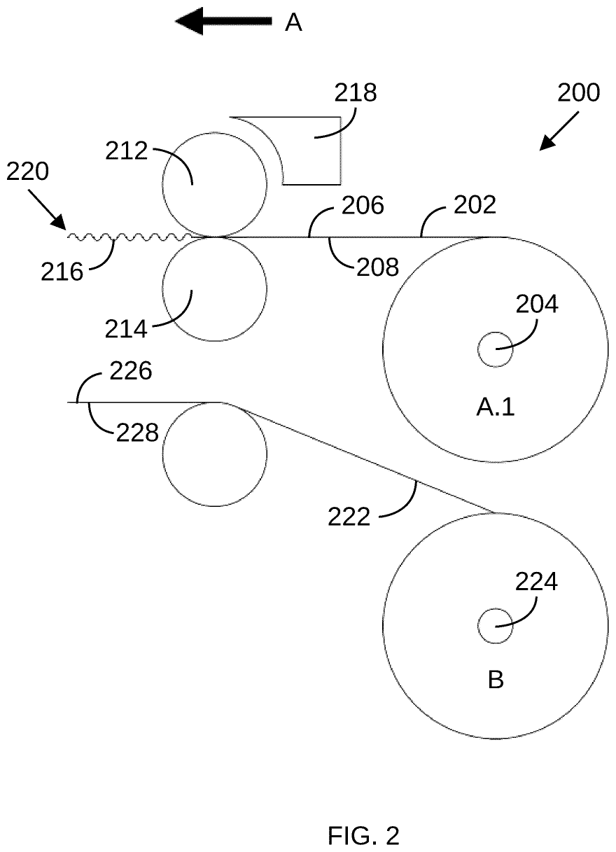

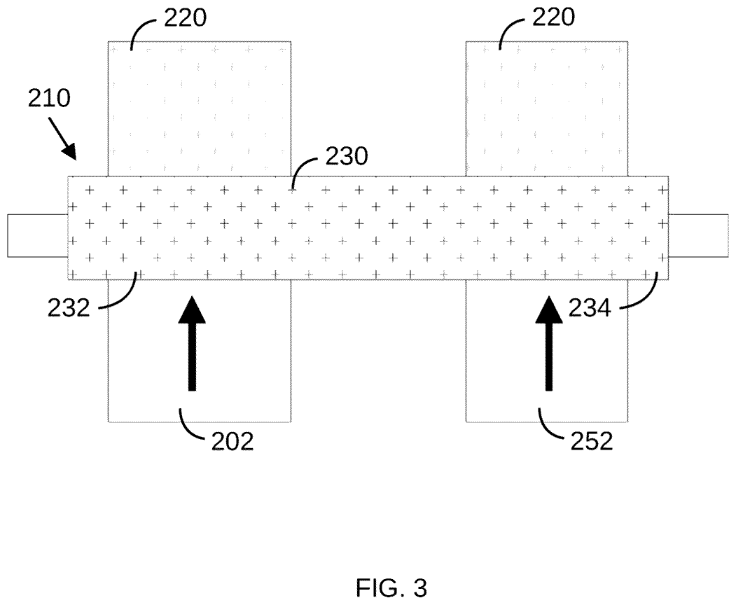

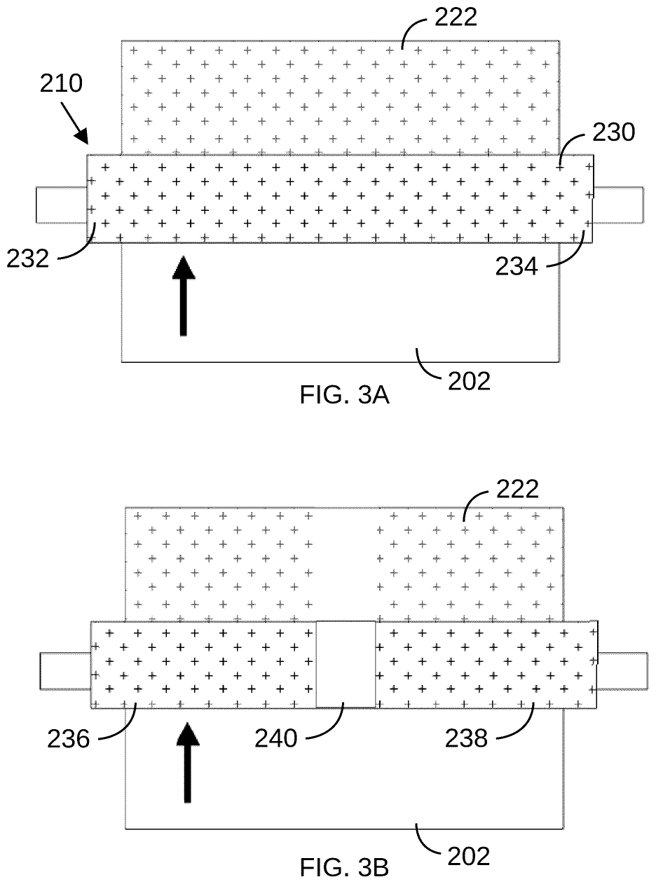

Referring now to FIGS. 2-3, which are schematics of a portion of the process for making a mailer, like mailer 100 illustrated in FIG. 1. This portion of the machine system 200, where utilized, is intended to emboss a first paper 202. As illustrated in FIGS. 2-3, the first paper 202 (i.e., rolled up) is unrolled from roll A1 by placing roll A1 onto an unwind cradle 204. The arrow A depicted in FIG. 2 represents the machine direction. The first paper 202 includes a first side 206 and a second side 208, where the first side 206 remains uncoated kraft paper, and the second side 208 is coated with a heat sealable coating, such as a polyolefin coating or a polyethylene coating (e.g., a low-density polyethene coating). The amount and/or type of coating on the paper may vary. For example, the heavier the weight of the kraft paper the thicker or heavier the heat-sealable coating may be. As a non-limiting example, a 60-pound kraft paper may have a 5 #low-density polyethylene coating, and a 40-pound kraft paper may have a 3.5 #low-density polyethylene coating. The kraft paper utilized may also vary in weight. As a non-limiting example 40-pound , 50-pound , or 60-pound kraft paper may be used. In some embodiments, the first paper 202, once unrolled from roll A1 by the unwind cradle 204, goes through an embosser 210.

The embosser 210 may, in some instances, include two separate rollers-a convex roller 212 and a concave roller 214—which together emboss or form a raised mirrored pattern 216 on the first paper 202. In some embodiments, the embosser 210 may be heated, for example, through a radiant heater 218; although, this is not intended to be limiting and any type of suitable heater may be utilized. In other implementations, the heating may be through the presence of a hot oil in a convex roller 212 and/or a concave roller 214 (e.g., hot oil may be pumped through the rollers). After the first paper 202 has passed through the embosser 210, an embossed paper 220 is formed. Although not illustrated in FIG. 2, this set up may be duplicated to form a side-by-side design (see e.g. FIG. 3) such that there is a second too-be-embossed paper 252 that is unrolled from roll AM (not illustrated) and also embossed by the embosser 210.

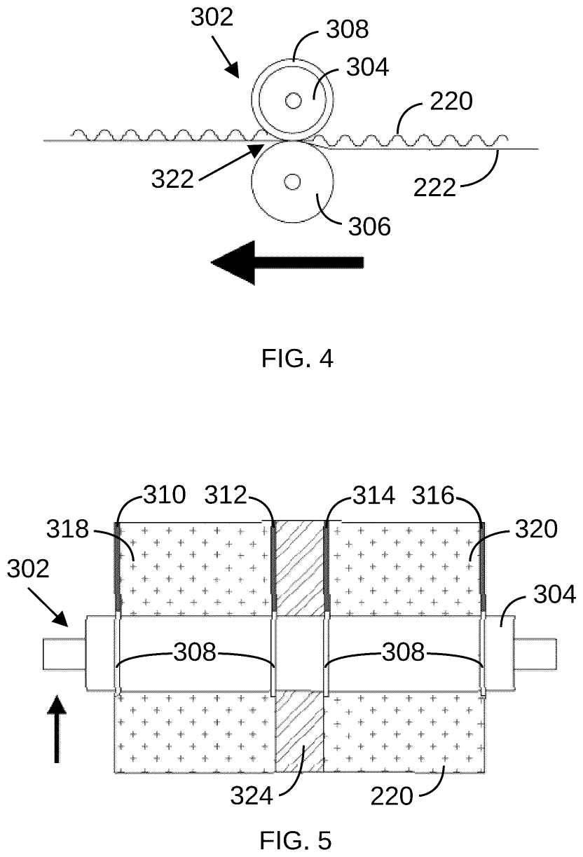

Referring specifically to FIG. 3, which is a top view, the embosser 210 is shown having a plurality of embossing stamps 230 that extend from a first end 232 of the embosser 210 to the second end 234 of the embosser 210. A side-by-side design allowing for two rolls (e.g. A1 and A) of paper (e.g., 202 and 252) to be embossed by the embosser 210 simultaneously. This results in two separate embossed papers that will eventually be mated with a second paper (see e.g., FIGS. 4-5).

Returning to FIG. 2, a second paper 222 is also illustrated on roll B, which is located on a second unwind cradle 224. The second paper 222 also includes a first side 226 and a second side 228, where the first side 226 remains uncoated kraft paper and the second side 228 is coated with a heat-sealable coating, for example a polyethylene coating such as a low-density polyethylene. As will be described and illustrated herein, this paper may be mated with the embossed paper 220 (see e.g. FIG. 4-5).

In some implementations, the finished mailer may not include an embossed portion as described with reference to FIGS. 1-3 (e.g., may not be a padded mailer). The mailer in such implementations would be identical to mailer 100 in other aspects, but would be a flat mailer, as opposed to including the embossed paper 220 described previously. In such embodiments, the process of forming the mailer may begin with the process described in FIGS. 4-5 without only the use of roll A located on an unwind cradle 224, as described with reference to FIG. 2.

Referring now to FIGS. 4 and 5, which illustrate the portion of the process for making a mailer, like mailer 100 illustrated in FIG. 1, intended to heat seal the embossed paper 220 and the second paper 222. Both the embossed paper 220 and the second paper 220 pass through the machine system 200 in a machine direction indicated by arrow A. A heat sealing mechanism 302 may be utilized to mate or seal the embossed paper 220 with the second paper 222. In some implementations, the heat sealing mechanism 302 may include a heat band roller 304. In other implementations, the heat sealing mechanism 302 may include a heat band roller 304 disposed proximate to the embossed paper 220 and a press roller 306 disposed proximate to the second paper 222, for example such that the embossed paper 220 and the second paper 222 are disposed between the heat band roller 304 and the press roller 306. In some implementations, the press roller 306 is constructed of silicone or contains a silicone coating on the exterior of the press roller 306. In such implementations, the combination of the heat and the pressure may facilitate mating the embossed paper 220 and the second paper 222 forming the seams of the mailer (see e.g., the first heat sealed edge 110 and second heat-sealed edge 112 of FIG. 1). In some implementations, the temperature utilized to heat-seal or mate the embossed paper 220 and the second paper 222 may range between about 350 degrees Fahrenheit and about 425 degrees Fahrenheit. The amount of pressure applied may also vary.

Referring specifically to FIG. 5, which is a top view, the heat band roller 304 disposed proximate to the embossed paper 220 includes a plurality of heated bands 308. In the embodiment illustrated in FIG. 5, there are four heated bands 308. Each of these heated bands 308 is disposed proximate to the heat band roller 304, such that the diameter of each of the heated bands 308 is larger than the diameter of the heated band roller 304. These heated bands 308 heat seal the embossed paper 220 and the second paper 222 together on the lateral edges of what will ultimately forms the mailer. In the embodiment illustrated in FIG. 5, four lateral heat sealed edges are formed by the heated bands 308: a first lateral edge 310; a second lateral edge 312; a third lateral edge 314; and a fourth lateral edge 316, each formed by one of the heated bands 308. The first and second lateral edges 310, 312 provide edges for the first multilayer material 318 that will form a first mailer while the third and fourth lateral edges 314, 316 provide edges for the second multilayer material 320 that will form a second mailer.

The embossed paper 220 and the second paper 222 mated together form a heat sealed paper 322; this heat sealed paper 322 forms the lateral edges or seams of the formed mailer(s). The heat sealing process may, in some implementations, leave an unmated portion 324 of the second paper 222 from roll B that remains only a single paper (the second paper 222) thick. This unmated portion 324 between the first mailer 318 and the second mailer 320 may form the lip section (see 114 in FIG. 1) of the formed mailer.

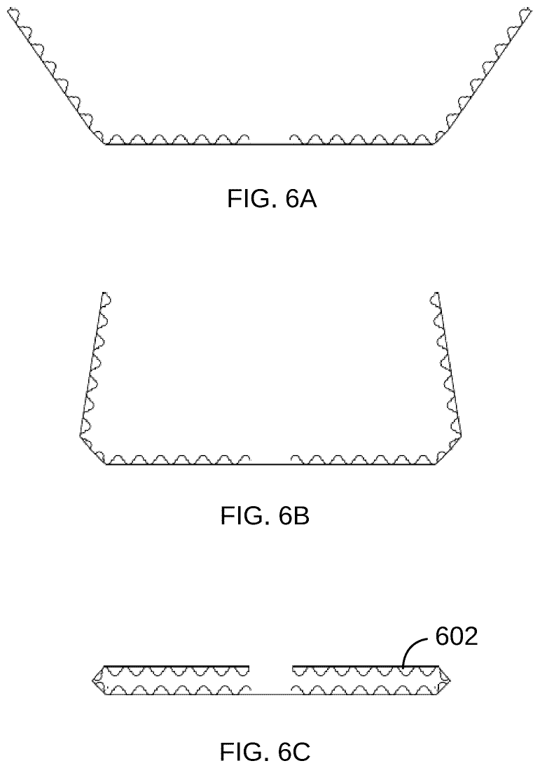

FIGS. 6A-C are schematic diagrams illustrating an exemplary sequence of folding of the heat sealed paper formed as illustrated and described with reference to FIGS. 4 and 5. FIG. 6A illustrates a first stage of the folding; FIG. 6B illustrates a second stage of the folding; and FIG. 6C illustrates a third stage of the folding and the folded paper 602. This folding may be performed with the aid of any number of known commercial folding apparatuses. The result of the folding process illustrated in FIGS. 6A-C is a continuous length of folded paper 602.

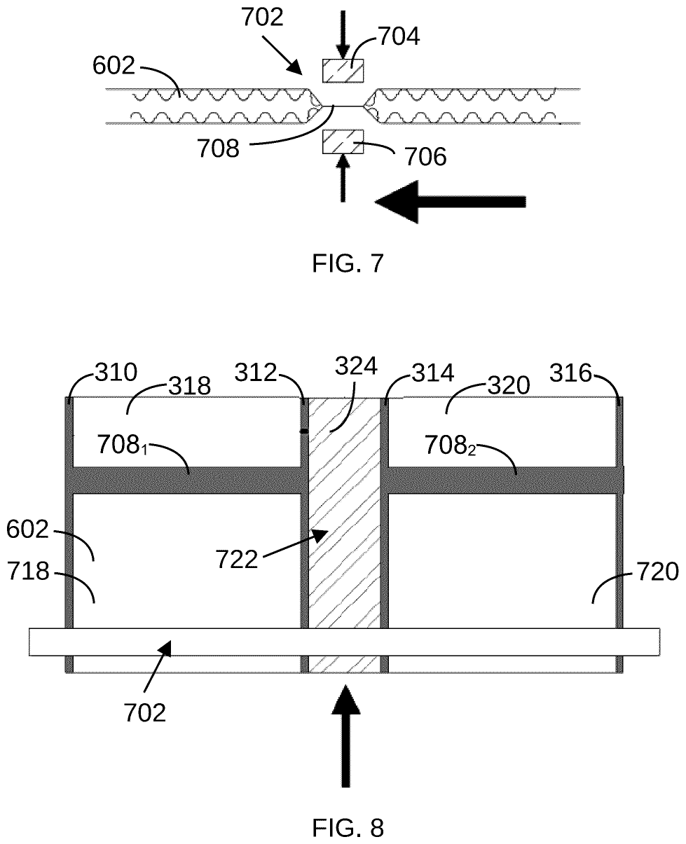

Turning now to FIGS. 7 and 8, a portion of a machine system with a continuous length of the folded paper 602 is illustrated. Arrow A, illustrated in each of FIGS. 7 and 8, represents the machine direction. Approximately 90 degrees, or about perpendicular to the machine direction is a heat sealer 702. The heat sealer 702 may, in some implementations, include a top part 704 and a bottom part 706 that may collectively apply heat and pressure to the folded paper 602 to form a width edge(s) 708 of the finished mailer. The dimensions of the mailer may vary depending on numerous factors including consumer preference, machine settings, or the like. The implementations discussed and illustrated herein are not intended to be dimensionally limited.

Referring specifically to FIG. 8, which is a top view of FIG. 7, a width edge 708 of the finished mailer is shown. FIG. 8 also illustrates how multiple mailers may be formed. As previously described, four lateral heat sealed edges are formed by the heated bands (see 308 in FIG. 5); these heat sealed edges include a first lateral edge 310; a second lateral edge 312; a third lateral edge 314; and a fourth lateral edge 316. As illustrated in FIG. 5, the first and second lateral edges 310, 312 provide edges for what will form a first mailer; this first multilayer material 318 that will ultimately form the first mailer now has a width edge 708₁. The third and fourth lateral edges 314, 316 provide edges for what form a second mailer; this second multilayer material 320 that will ultimately form the second mailer now has a width edge 708₂.

Once the heat sealer 702 applies heat and pressure to the folded paper 602 to form the width edge(s) 708 of the finished mailer a third mailer 718 and a fourth mailer 720 may form. This process may continue repeatedly along the continuous length of folded paper 602.

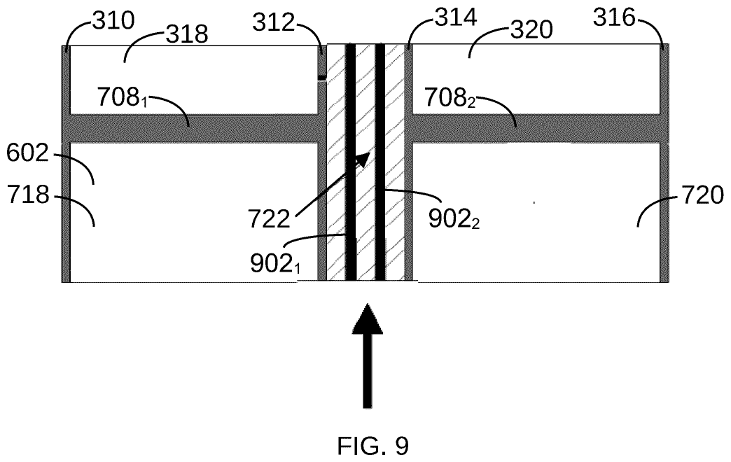

FIG. 8 also illustrates the unmated portion 324 (of the second paper 222), for example between the first mailer 318 and the second mailer 320 (or the third mailer 718 and fourth mailer 720) may form the lip section 722. Referring specifically now to FIG. 9, the lip section 722 may additionally include a closure adhesive 902 that may be used by a consumer to seal the mailer closed once the contents are inserted. In the implementation illustrated in FIG. 9, there is a first closure adhesive 902₁ disposed proximate and about parallel with the second lateral edge 312 that may serve as the closure adhesive for closing the first mailer 318 and the third mailer 718. The implementation of FIG. 9 also includes a second closure adhesive 902₂ disposed proximate and about parallel with the third lateral edge 314 that may serve as the closure adhesive for closing the second mailer 320 and the fourth mailer 720.

In some implementations, this closure adhesive 902 may be a gum seal adhesive that may dry into a non-sticky layer but can be reactivated after the introduction of water (e.g., licking). In other implementations, the closure adhesive 902 could be a peel and stick or double-sided tape adhesive. The type of adhesive utilized is not intended to be limiting, and as a person of skill in the art would recognize numerous types of adhesives may be used as a closure adhesive for with the mailer.

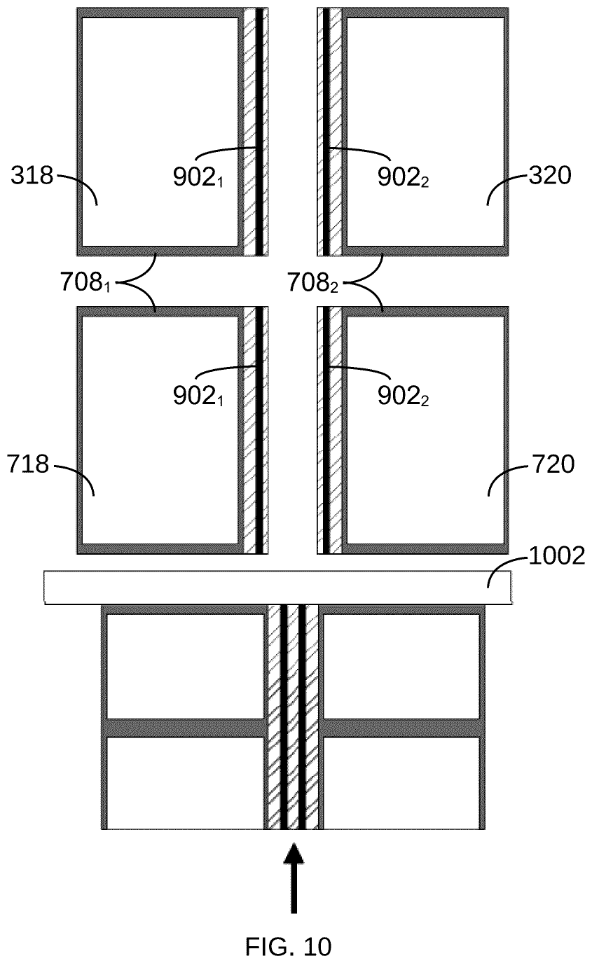

FIG. 10 illustrates a top view of the portion of the machine system intended to cross-cut the formed mailers along a continuous length into individual mailers. A guillotine cutter 1002 is illustrated approximately 90 degrees, or about perpendicular to the machine direction (illustrated by arrow A). This index and/or cross-cutter 1002 may center heat sealed width edge(s) 708 and cut within this heat sealed width edge 708. Similarly, the guillotine cutter 1002 may cut between the first closure adhesive 902₁ and the second closure adhesive 902₂. This will allow separation into individual mailers, for example the first mailer 318, second mailer 320, third mailer 718, and fourth mailer 720. This process may continue until a desired number of finished mailers are produced.

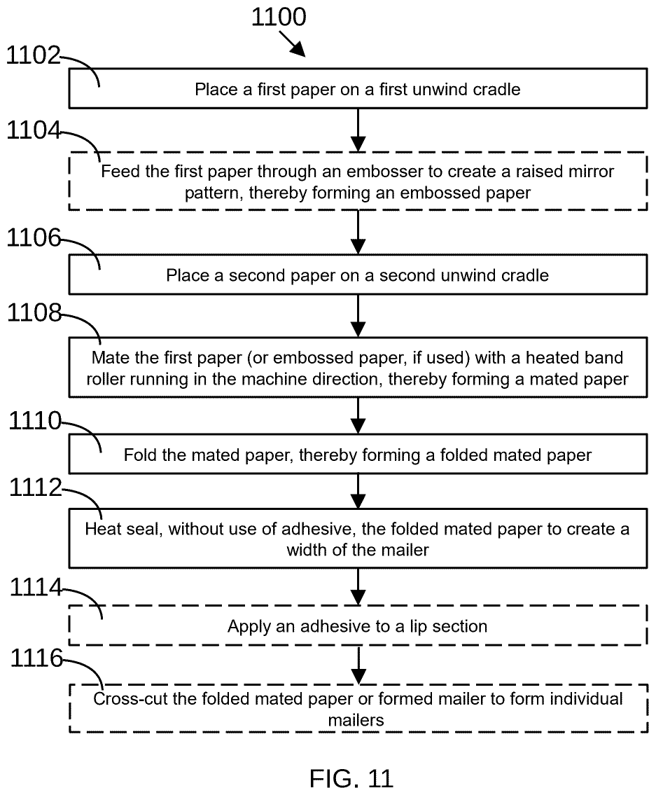

Now turning to FIG. 11, this figure is a flowchart that illustrates an example manufacturing method 1100 to produce an embodiment of the mailer described herein (and, for example, illustrated in FIG. 1). It will be appreciated that the method 1100 described herein may be altered by a person of skill in the art.

At block 1102, a first paper is placed on an unwind cradle (see e.g., FIGS. 2-3). At optional block 1104, this first paper is fed through an embosser (as described with reference to FIGS. 2-3) to create a raised mirror pattern. This process forms an embossed paper. At block 1106, a second paper is placed on a second unwind cradle (see e.g., FIGS. 2-3).

At block 1108 the embossed paper and the second paper are mated together by a heated band roller (as shown and described with reference to FIGS. 4 and 5), without use of adhesive. This process forms a multilayer material or mated paper. After the papers are heat sealed in block 1108, the mated paper is folded along a continuous length, at block 1110, to form a folded multilayer material or mated paper.

At block 1112, the folded multilayer material or mated paper is heat sealed, without the use of adhesive, to form a width of the mailer (as illustrated and described with reference to FIGS. 7 and 8). At optional block 1114, a closure adhesive to a lip section to allow a consumer to seal the mailer for use (as illustrated and described with reference to FIG. 9). At optional block 1116, the mailer(s) along the continuous length may be indexed and/or cross-cut to form individual mailers of a to a desired dimension (as illustrated and described with reference to FIG. 10). In some implementations, block 1112 and block 1116 may occur simultaneously.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to An only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A method of producing a mailer, the method comprising:
placing a first paper on a first unwind cradle, wherein the first paper includes a first side and a second side, and the first side is coated with a heat sealable coating;
placing a second paper on a second unwind cradle, wherein the second paper includes a first side and a second side, and the first side is coated with the heat sealable coating;
mating the first paper and the second paper using a heated band roller running in a machine direction, thereby forming a mated paper;
folding, via a guided folder, the mated paper, thereby forming a folded mated paper; and
heat sealing, without use of adhesive, the folded mated paper to create a width of the mailer.

2. The method of producing a mailer of claim 1, wherein the heat sealable coating is a low-density polyethylene.

3. The method of producing a mailer of claim 1, wherein the first paper is a 40 pound kraft paper, a 50 pound kraft paper, or a 60 pound kraft paper.

4. The method of producing a mailer of claim 1 further includes cutting the folded mated paper to a desired width.

5. The method of producing a mailer of claim 1, wherein the heated band roller is a first heated band roller and there is a second heated band roller, wherein there is a gap between the first heated band roller and the second heated band roller.

6. A method of producing a padded mailer, the method comprising:
placing a first paper on a first unwind cradle, wherein the first paper includes a first side and a second side, and the first side is coated with a heat sealable coating;
feeding the first paper through an embosser to create a raised mirror pattern, thereby forming an embossed paper;
placing a second paper on a second unwind cradle, wherein the second paper includes a first side and a second side, and the first side is coated with the heat sealable coating;
mating the embossed paper and the second paper with a heated band roller running in a machine direction, thereby forming a mated paper;
folding, via a guided folder, the mated paper, thereby forming a folded mated paper; and
heat sealing, without use of adhesive, the folded mated paper to create a width of the padded mailer.

7. The method of producing a padded mailer of claim 6, wherein the heat sealable coating is a low-density polyethylene.

8. The method of producing a padded mailer of claim 6, wherein the first paper is a 40 pound paper, a 50 pound paper, or a 60 pound paper.

9. The method of producing a padded mailer of claim 8, wherein the mating further includes leaving a lip section on the second paper.

10. The method of producing a padded mailer of claim 9, wherein the method further includes applying a closure adhesive to the lip section.

11. The method of producing a padded mailer of claim 6 further includes cutting the folded mated paper to a desired width.

12. The method of producing a padded mailer of claim 6, wherein the feeding the first paper through an embosser to create a raised mirror pattern further includes applying heat.

13. The method of producing a padded mailer of claim 12, wherein the applying heat is through a radiant heater.

14. The method of producing a padded mailer of claim 6, wherein the embosser includes a convex roller and a concave roller.

15. The method of producing a padded mailer of claim 6, wherein the heated band roller is a first heated band roller and there is a second heated band roller, wherein there is a gap between the first heated band roller and the second heated band roller.

16. A method of producing a padded mailer, the method comprising:
placing a first paper on a first unwind cradle, wherein the first paper includes a first side and a second side, and the first side is coated with a heat sealable coating;
feeding the first paper through an embosser while applying heat to create a raised mirror pattern, thereby forming an embossed paper;
placing a second paper on a second unwind cradle, wherein the second paper includes a first side and a second side, and the first side is coated with the heat sealable coating;
mating the embossed paper with a heated band roller running in a machine direction, thereby forming a mated paper;
wherein the mating further includes leaving a lip section on the second paper;
folding, via a guided folder, the mated paper, thereby forming a folded mated paper;
applying a closure adhesive to the lip section; and
heat sealing, without use of adhesive, the folded mated paper to create a width of the padded mailer.

17. The method of producing a padded mailer of claim 16, wherein the heated band roller is a first heated band roller and there is a second heated band roller, wherein there is a gap between the first heated band roller and the second heated band roller.

18. The method of claim 6, wherein the padded mailer contains less than about 15% plastic or non-recoverable material.
